(19) United States
(12) Patent Application Publication
(10) Pub. No.: US 2026/0055246 A1
(43) Pub. Date: Feb. 26, 2026

(54) POLYMER FILMS, METHODS FOR PREPARING THEREOF, AND COMPOSITE CURRENT COLLECTORS THEREOF

(71) Applicant: JIANGYIN NANOPORE INNOVATIVE MATERIALS TECHNOLOGY LTD, Jiangsu (CN)

(72) Inventors: Zhongya Zhu, Jiangsu (CN); Jianzhong Xia, Jiangsu (CN); Xuefa Li, Jiangsu (CN); Guoping Zhang, Jiangsu (CN)

(73) Assignee: Jiangyin Nanopore Innovative Materials Technology Ltd., Jiangsu (CN)

(21) Appl. No.: 19/104,532

(22) PCT Filed: Aug. 18, 2023
(86) PCT No.: PCT/CN2023/113698

§ 371 Date: Feb. 18, 2025

(30) Foreign Application Priority Data
Aug. 18, 2022 (CN) 202210989670.5
Mar. 13, 2023 (WO) PCT/CN2023/081023

(51) Int. Cl. C08J 3/24; C08J 5/18; H01M 4/66

(52) U.S. Cl. CPC C08J 3/247; C08J 5/18; H01M 4/667; C08J 2323/12; C08J 2367/02

(57) ABSTRACT

Disclosed herein are a polymer film, a method for preparing the same, and a composite current collector comprising the same. The polymer film preparation method comprises soaking, washing, and heat treatment, wherein a polymer film is subjected to a crosslinking treatment with a crosslinking agent to improve its tensile strength and heat resistance.

### CROSS-REFERENCE TO RELATED APPLICATIONS

This application claims priority to and benefits of Chinese patent application No. 202210989670.5, filed on Aug. 18, 2022, and international patent application No. PCT/CN2023/081023, filed on Mar. 13, 2023, the contents of which are hereby incorporated by reference.

### TECHNICAL FIELD

The present disclosure is in the technical field of current collector production, and is, in particular, related to a polymer film, a method for preparing the same, and a composite current collector comprising the same.

### BACKGROUND

In electronics, packaging, printing, etc., a metallized polymer film is usually formed by depositing metals on a polymer film through the physical vapor deposition technology. This metallized polymer film has good electroconductivity, barrier property and flexibility, and exhibits an advantage of light weight. The materials prepared by this technology include composite current collectors, film electrodes, aluminum-plated packaging films, printed films, etc. This metallized polymer film has significant advantages over metal films during use, and therefore has been widely used.

However, in preparation of the metallized polymer film, conventional polymer films, usually being polymer films made of polypropylene, polyethylene, polyester, etc., are prone to being damaged due to their low tensile strength, and thereby reducing the yield of products. Moreover, the physical vapor deposition process and the product composite process involved in the subsequent application also have relatively high demand on the tensile strength of the polymer films. In addition, the conventional polymer films with poor heat resistance will lead to volume shrinkage at a high temperature and thus will be separated from the metal layers, which have good heat resistance. Therefore, there is a need to improve the heat resistance and tensile strength of the polymer films.

### SUMMARY

The present disclosure provides a polymer film, a method for preparing the same, and a composite current collector comprising the same.

In an aspect of the present disclosure, a method for preparing a polymer film is disclosed, in which a polymer film is chemically cross-linked with a crosslinking agent.

In some embodiments, a method for preparing a polymer film comprises:
(i) soaking a polymer film in a solution containing a crosslinking agent, which is capable of forming a carbene intermediate, for a crosslinking reaction;
(ii) washing the polymer film obtained after step (i) with, for example, water; and
(iii) heat-treating the washed polymer film, for example, in an oven;
wherein the crosslinking agent is capable of forming carbene intermediates.

The heat-treated polymer film is the polymer film that has been chemically cross-linked.

In an embodiment, during the soaking in step (i), the soaking is performed for a time period ranging from 5 to 60 minutes. The solution containing the crosslinking agent during the soaking has a temperature ranging from 40° C. to 110° C. In an embodiment, the solution containing the crosslinking agent during the soaking has a temperature ranging from 40° C. to 95° C.

During the washing in step (ii), the polymer film is, for example, purged with an air knife for a time period ranging from 5 to 30 seconds to remove residual solution on the surface of the polymer film, and then washed in deionized water for a time period ranging from 0.5 to 3 minutes to remove remaining residual solution on the surface of the polymer film.

During the heat treatment of step (iii), the washed polymer film is, for example, purged with an air knife for a time period ranging from 5 to 30 seconds, and then heat-treated in an oven at a temperature ranging from 50° C. to 90° C. for a time period ranging from 1 to 5 minutes.

After the heat treatment, a polymer film with enhanced heat resistance and tensile strength is obtained.

In an embodiment, a base material of the polymer film is one or more selected from polypropylene (PP), polyethylene (PE), polyethylene terephthalate (PET), polybutylene terephthalate (PBT), polyethylene naphthalate (PEN), polyimide (PI), polypropyl ethylene, polyvinyl chloride (PVC), polyvinylidene fluoride (PVDF), polytetrafluoroethylene (PTFE), polyphenylene sulfide (PPS), polyphenylene oxide (PPO), polystyrene (PS), derivatives thereof, and copolymers thereof.

In an embodiment, a thickness of the polymer film is equal to or greater than 1 μm. In an embodiment, a thickness of the polymer film is equal to or smaller than 10 μm.

As disclosed herein, in some embodiments, the crosslinking agent comprises a compound capable of forming a carbene intermediate. In an embodiment, the crosslinking agent comprises a compound of Formula I:

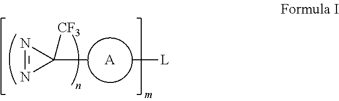

in which
A is an aryl group selected from substituted or unsubstituted phenyl, substituted or unsubstituted pyridine, and substituted or unsubstituted biphenyl, in which the substituent is each independently selected from halogen, hydroxyl, C1-C8 alkyl, C1-C8 haloalkyl, C1-C8 alkoxyl, C3-C8 cycloalkyl, and C3-C8 halocycloalkyl;
L is selected from a bond, and substituted or unsubstituted C1-C8 alkyl, in which the substituent is each independently selected from halogen, hydroxyl, C1-C8 alkyl, C1-C8 haloalkyl, C1-C8 alkoxyl, C3-C8 cycloalkyl, and C3-C8 halocycloalkyl;
m is an integer selected from 1, 2, 3, and 4;
n is an integer selected from 1, 2, and 3.

In some embodiments, L is a C3-C8 perfluoroalkyl.

In some embodiments, A is an aryl group selected from phenyl, pyridine, and biphenyl, optionally substituted with one or more halogen atom(s).

In an embodiment, the crosslinking agent is selected from:
1,3-bis(3-(trifluoromethyl)-3H-diazirin-3-yl) benzene,
1,3-bis(3-(trifluoromethyl)-3H-diazirin-3-yl)-2-(trifluoromethyl) benzene,
3,3′-((perfluorooctane-1,8-diyl) bis(4,1-phenylene)) bis(3-(trifluoromethyl)-3H-diazirine),
3,3′-((perfluorooctane-1,8-diyl) bis(2,3,5,6-tetrafluoro-4,1-phenylene)) bis(3-(trifluoromethyl)-3H-diazirine),
1,3,5-tris(3-(trifluoromethyl)-3H-diazirin-3-yl) benzene,
tetrakis (4-(3-(trifluoromethyl)-3H-diazirin-3-yl)phenyl) methane,
tetrakis (4′-(3-(trifluoromethyl)-3H-diazirin-3-yl) [1,1′-biphenyl]-4-yl) methane,
3,5-bis(3-(trifluoromethyl)-3H-diazirin-3-yl) pyridine, and
3,3′-((perfluoropropane-2,2-diyl) bis(4,1-phenylene)) bis(3-(trifluoromethyl)-3H-diazirine).

In an embodiment, the crosslinking agent is selected from:
1,3-bis(3-(trifluoromethyl)-3H-diazirin-3-yl) benzene, 1,3-bis(3-(trifluoromethyl)-3H-diazirin-3-yl)-2-(trifluoromethyl) benzene, 3,5-bis(3-(trifluoromethyl)-3H-diazirin-3-yl) pyridine, and 3,3′-((perfluoropropane-2,2-diyl) bis(4,1-phenylene)) bis(3-(trifluoromethyl)-3H-diazirine).

The chemical structural formulae of the above crosslinking agents are as follows:

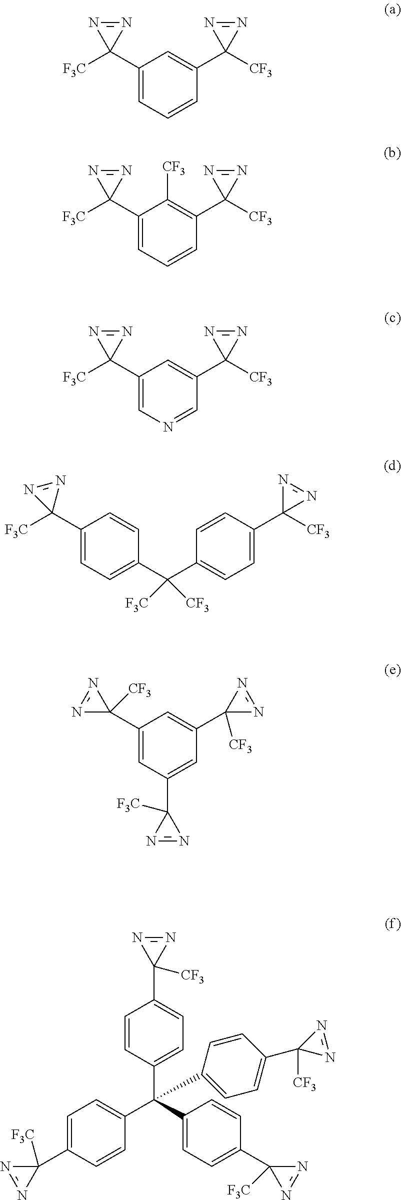

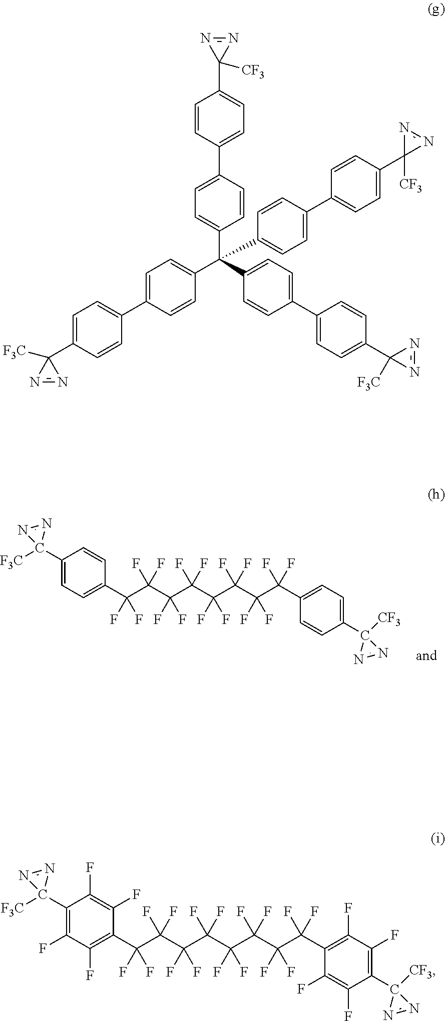

in which, (a) is 1,3-bis(3-(trifluoromethyl)-3H-diazirin-3-yl) benzene; (b) is 1,3-bis(3-(trifluoromethyl)-3H-diazirin-3-yl)-2-(trifluoromethyl) benzene; (c) is 3,5-bis(3-(trifluoromethyl)-3H-diazirin-3-yl) pyridine; (d) is 3,3′-((perfluoropropane-2,2-diyl) bis(4,1-phenylene)) bis(3-(trifluoromethyl)-3H-diazirine); (e) is 1,3,5-tris(3-(trifluoromethyl)-3H-diazirin-3-yl) benzene; (f) is tetrakis (4-(3-(trifluoromethyl)-3H-diazirin-3-yl)phenyl) methane; (g) is tetrakis (4′-(3-(trifluoromethyl)-3H-diazirin-3-yl) [1,1′-biphenyl]-4-yl) methane; (h) is 3,3′-((perfluorooctane-1,8-diyl) bis(4,1-phenylene)) bis(3-(trifluoromethyl)-3H-diazirine); and (i) is 3,3′-((perfluorooctane-1,8-diyl) bis(2,3,5,6-tetrafluoro-4,1-phenylene)) bis(3-(trifluoromethyl)-3H-diazirine).

In an embodiment, the solution containing the crosslinking agent comprises at least one solvent selected from: ethyl ether, acetone, N, N-dimethylformamide, N, N-dimethylacetamide, pyridine, 2-dimethylpyridine, pyridone, and benzene.

In an embodiment, the solution containing the crosslinking agent has a concentration of the crosslinking agent ranging from 5 g/L to 200 g/L. In an embodiment, the concentration of the crosslinking agent in the solution ranges from 80 g/L to 170 g/L. When the concentration is too low, the reaction speed is slow; while when the concentration is too high, the reaction speed is too fast to be controlled.

In a further aspect, disclosed herein is a polymer film prepared by the method as described above.

When soaked in the solution containing the crosslinking agent, the polymer film is subjected to a crosslinking reaction. Specifically, carbene intermediates generated by the crosslinking agent under a heating condition attack the carbon-hydrogen bonds of the methylene groups in the polymer molecules, which produces an addition reaction to achieve the crosslinking. The cross-linked polymers disclosed herein have a high degree of crosslinking, which increases the rigidity of the polymer molecular chain, therefore the heat resistance and tensile strength thereof have been greatly improved. By soaking the polymer film in the solution containing a crosslinker, the crosslinker can penetrate into the film layer through the free volume of the polymer and hence results in polymerization throughout the entire volume of the film. Thus, the mechanical properties of the entire polymer film can uniformly be improved. Moreover, since the crosslinking reaction leads to covalent carbon-carbon bonds and does not introduce polar moieties, polarity of the polymer film disclosed herein remains steady and thus the surface tension of the polymer film disclosed herein does not change much after crosslinking.

Disclosed herein is a modified polymer film with improved heat resistance and tensile strength for use in a composite current collector. In an embodiment, the polymer film disclosed herein comprises a repetitive moiety selected from:

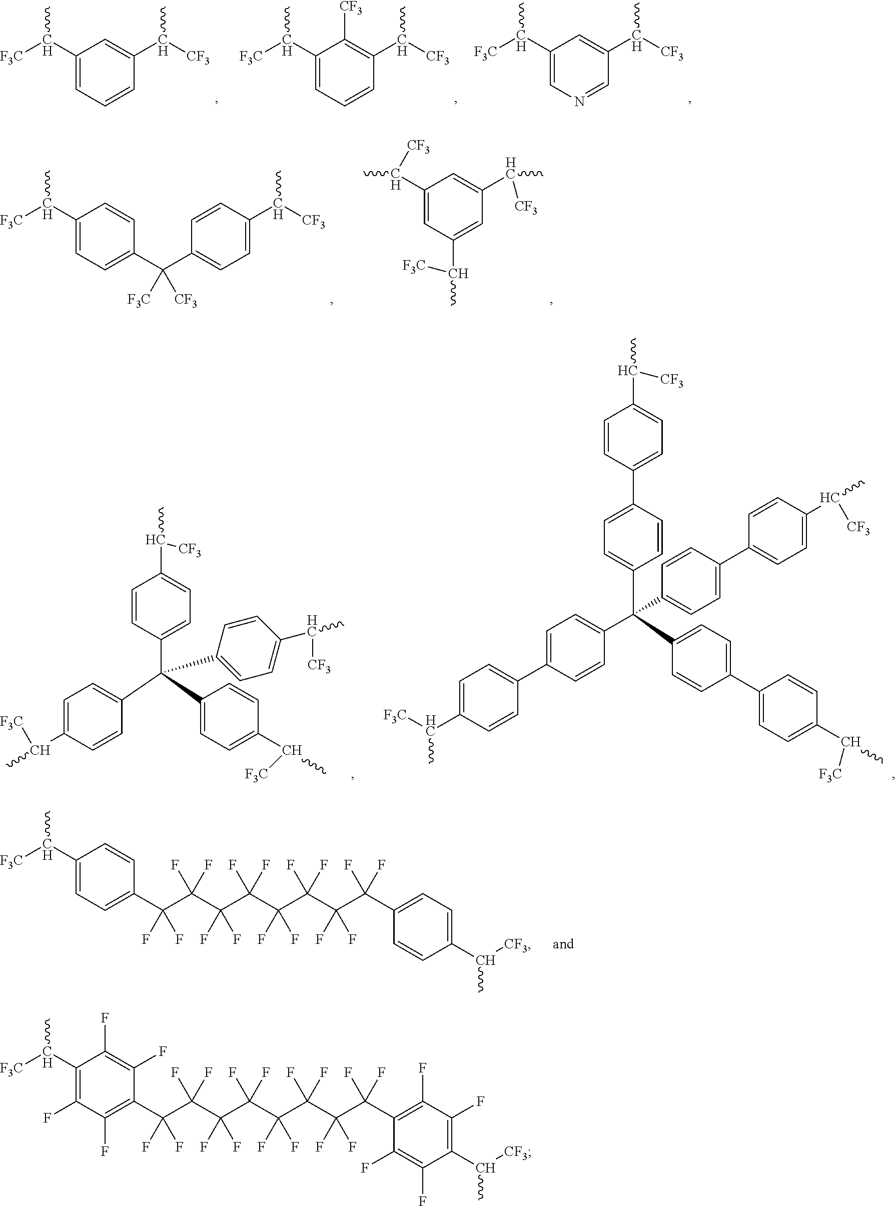

and a polymeric network formed by one or more base materials selected from polypropylene (PP), polyethylene (PE), polyethylene terephthalate (PET), polybutylene terephthalate (PBT), polyethylene naphthalate (PEN), polyimide (PI), polypropyl ethylene, polyvinyl chloride (PVC), polyvinylidene fluoride (PVDF), polytetrafluoroethylene (PTFE), polyphenylene sulfide (PPS), polyphenylene oxide (PPO), polystyrene (PS), the derivatives thereof, and the copolymers thereof.

In some embodiments, the repetitive moiety constitutes 0.1 wt % to 2.0 wt % based on the total weight of the polymer film.

In some embodiments, the present disclosure provides a polymer film comprising a repetitive moiety selected from:

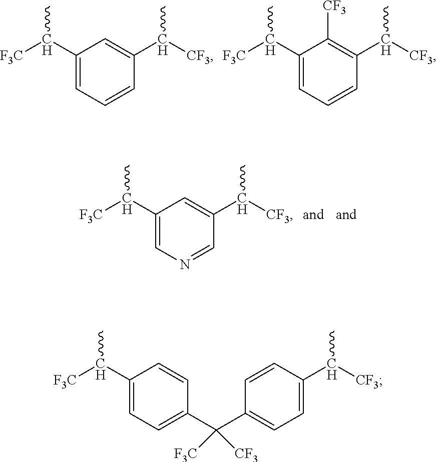

a polymeric network formed by one or more base materials selected from polypropylene (PP), polyethylene (PE), polyethylene terephthalate (PET), polybutylene terephthalate (PBT), polyethylene naphthalate (PEN), polyimide (PI), polypropyl ethylene, polyvinyl chloride (PVC), polyvinylidene fluoride (PVDF), polytetrafluoroethylene (PTFE), polyphenylene sulfide (PPS), polyphenylene oxide (PPO), polystyrene (PS), the derivatives thereof, and the copolymers thereof.

In some embodiments, the weight average molecular weight of the modified polymer film is increased by 2% to 35% after the treatment according to the method of the present disclosure. The weight average molecular weight of the modified polymer film is measured, for example, according to GB/T 36214.1-2018.

In some embodiments, the tensile strength of the modified polymer film ranges from 200-400 MPa, measured accordingly to, for example, GB/T 1040.3-2006. In some embodiments, the heat resistance of the modified polymer film ranges from 0.1%-3.5%, measured according to, for example, GB/T 10003-2008.

In a furthermore aspect, the present disclosure provides a composite current collector, comprising a metallized polymer film prepared with the polymer film as described above. The composite current collector includes a composite positive electrode current collector and a composite negative electrode current collector.

In some embodiments, the present disclosure provides a composite current collector comprising:
a polymer film comprising a repetitive moiety selected from:

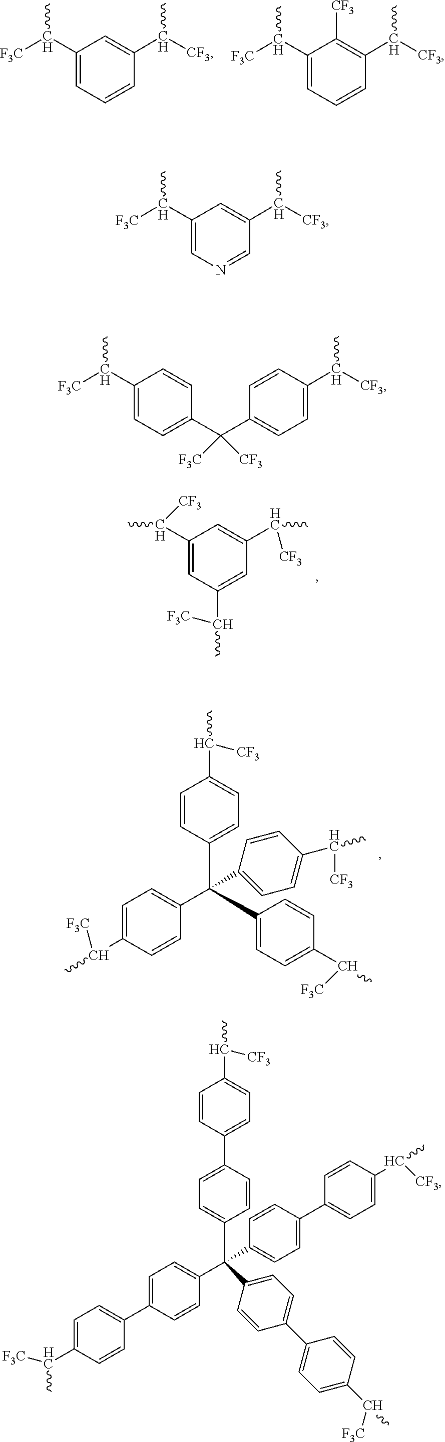

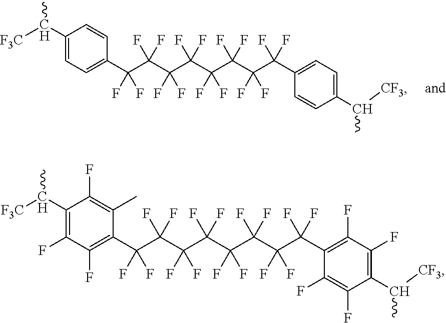

a polymeric network formed by one or more base materials selected from polypropylene (PP), polyethylene (PE), polyethylene terephthalate (PET), polybutylene terephthalate (PBT), polyethylene naphthalate (PEN), polyimide (PI), polypropyl ethylene, polyvinyl chloride (PVC), polyvinylidene fluoride (PVDF), polytetrafluoroethylene (PTFE), polyphenylene sulfide (PPS), polyphenylene oxide (PPO), polystyrene (PS), the derivatives thereof, and the copolymers thereof; and
metal layers disposed on two opposing surfaces of the polymer film.

In some embodiments, the present disclosure provides a composite current collector comprising:
a polymer film comprising a repetitive moiety selected from:

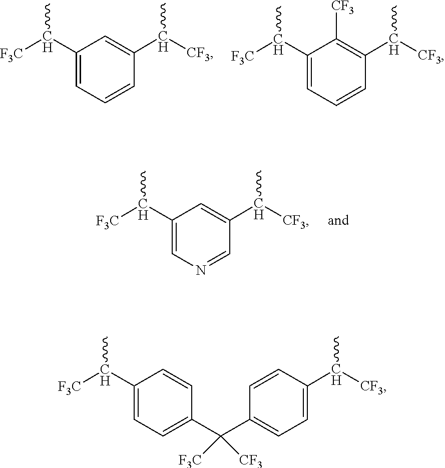

a polymeric network formed by one or more base materials selected from polypropylene (PP), polyethylene (PE), polyethylene terephthalate (PET), polybutylene terephthalate (PBT), polyethylene naphthalate (PEN), polyimide (PI), polypropyl ethylene, polyvinyl chloride (PVC), polyvinylidene fluoride (PVDF), polytetrafluoroethylene (PTFE), polyphenylene sulfide (PPS), polyphenylene oxide (PPO), polystyrene (PS), the derivatives thereof, and the copolymers thereof; and
metal layers disposed on two opposing surfaces of the polymer film.

In some embodiments, the composite current collector is a composite positive electrode current collector, in which the metal layers disposed on two opposing surfaces of the polymer film are aluminum layers. In some embodiments, the composite current collector is a composite negative electrode current collector, in which the metal layers disposed on two opposing surfaces of the polymer film are copper layers.

In some embodiments, the composite current collector disclosed herein further comprises at least one protective layer on the surface of the metal layers. The protective layer comprises one or more selected from nickel, chromium, nickel-based alloys, copper-based alloys, copper oxide, aluminum oxide, nickel oxide, chromium oxide, copper chromate, cobalt oxide, graphite, carbon black, acetylene black, Ketjen black, carbon nano quantum dots, carbon nanotubes, carbon nano fiber, and graphene.

In some embodiments, the present disclosure also provides a method of producing the composite current collector, comprising:
providing a polymer film according to the method described above; and
disposing metal layers on two opposing surfaces of the polymer film.

An electrode sheet can be prepared with the composite current collector as described above. The electrode sheet includes a positive electrode sheet and a negative electrode sheet. The positive electrode sheet is formed by applying a positive electrode active material on the composite positive electrode current collector. The negative electrode sheet is formed by applying a negative electrode active material on the composite negative electrode current collector.

A battery can be prepared with the electrode sheets as described above. In an embodiment, the battery is prepared with the aforementioned positive electrode sheet and the aforementioned negative electrode sheet.

The polymer film, the polymer film preparation method, and the composite current collector disclosed herein have the following advantages in comparison with what is known in the art:
(i) The polymer film preparation method disclosed herein is simple and easy to operate with a modification treatment on the existing polymer film, and has high production efficiency;
(ii) The polymer film preparation method disclosed herein has low cost and high economic benefit;
(iii) The polymer film disclosed herein has high tensile strength. When the polymer film is used as a substrate to form a metallized polymer film and the metallized polymer film is used as a composite current collector, the film breakage due to low tensile strength of the film occurring during the preparation and subsequent application of the composite current collector can be effectively prevented from and the yield rate of the composite current collector can be increased. Further, the resulting metallized polymer film can have greatly improved heat resistance;
(iv) Electrode sheets can be formed by applying active materials on the composite current collectors prepared with the polymer films disclosed herein. A battery can be further prepared with the electrode sheet. The composite current collector, the electrode sheet, and the battery can have excellent properties based on the excellent mechanical properties of the polymer film disclosed herein.

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” or “containing” as used herein will be understood to mean that the list following is non-exhaustive and may or may not include any other additional suitable items, for example one or more further feature(s), component(s) and/or ingredient(s) as appropriate.

The term “alkyl” refers to a hydrocarbon group selected from linear and branched saturated hydrocarbon groups with certain number of carbon atoms, preferably 1 to 6 carbon atoms, particularly 1 to 4 carbon atoms. Nonlimiting examples include methyl, ethyl, n-propyl, isopropyl, tert-butyl, n-pentyl and n-hexyl.

The term “cycloalkyl” refers to refers to a hydrocarbon group selected from saturated and partially unsaturated cyclic hydrocarbon groups, comprising monocyclic and polycyclic (e.g., bicyclic and tricyclic) groups. The ring may be saturated or have at least one double bond (i.e. partially unsaturated), but is not fully conjugated, and is not aromatic, as aromatic is defined herein.

The term “alkoxy” represents an alkyl group as described above with a specific number of carbon atoms which is connected by an oxygen bridge. For example, the C₁-C₆ alkoxy includes C₁, C₂, C₃, C₄, C₅ and C₆ alkoxy. Examples of alkoxy include but not limited to: methoxy, ethoxy, n-propoxy, iso-propoxy, n-butoxy, sec-butoxy, tert-butoxy, n-pentyloxy and S-pentyloxy.

As used herein, the term “substituted” refers to any one or more hydrogen atoms on a specific atom being optionally replaced by a substituent, as long as the valence state of the specific atom is normal and the substituted compound is stable.

Unless otherwise specified, the term “halo” or “halogen” itself or as a part of another substituent refers to a fluorine, chlorine, bromine or iodine. In addition, the term “haloalkyl” is intended to include monohaloalkyl and polyhaloalkyl. Examples of haloalkyl include but are not limited to: trifluoromethyl, trichloromethyl, pentafluoroethyl, and pentachloroethyl.

The term “aryl” herein refers to a group selected from: 3- to 6-membered carbocyclic aromatic rings, for example, phenyl; bicyclic ring systems such as 7-12 membered bicyclic ring systems wherein at least one ring is carbocyclic and aromatic, selected, for example, from naphthalene, indane, and 1,2,3,4-tetrahydroquinoline.

As used herein, “carbene” is an electronically neutral species comprising a carbon having two nonbonding electrons (i.e., form a lone pair), which is referred to as the “carbene carbon.” In the carbenes used in the method and materials of the present application, this carbon having the two nonbonding electrons is the carbon that will be bound to a metal surface and is divalent; in other words, this carbon is covalently bonded to two substituents of any kind, and bears two nonbonding electrons that may be spin-paired (singlet state), such that the carbon is available for formation of a dative bond.

The term “crosslinker” or “crosslinking agent” refers to a molecule capable of forming a covalent linkage between polymers or between two different regions of the same polymer.

The technical solution of the present disclosure will be set forth below in detail by particular Examples and Comparative Examples.

### Example 1

### 1. Preparation of Polymer Film

Materials were selected as following: commercially available polypropylene (PP) film with a thickness of 4.5 μm as a polymer film (i.e., base film); 3,3′-((perfluoropropane-2,2-diyl) bis(4,1-phenylene)) bis(3-(trifluoromethyl)-3H-diazirine) as a crosslinking agent; N,N-dimethylformamide as a solvent of the crosslinking agent. The materials all were analytically pure.

Preparation of a solution containing a crosslinking agent: 20.00 g of 3,3′-((perfluoropropane-2,2-diyl) bis(4,1-phenylene)) bis(3-(trifluoromethyl)-3H-diazirine) as the crosslinking agent was added into 1 L of N, N-dimethylformamide at room temperature, then stirred at a stirring speed of 500 rpm to completely dissolve. Thus, a crosslinking agent solution with a concentration of 20 g/L was obtained.

Crosslinking treatment for modification: The obtained solution containing the crosslinking agent was heated to a temperature of 80° C. After the solution reached the stable temperature, the polypropylene (PP) base film was soaked in the solution containing the crosslinking agent for 30 minutes. After the soaking, the polypropylene (PP) base film was purged with an air knife for 15 seconds to remove the residual solution on the surface of the base film, and then washed for 1.0 minute in a washing container containing deionized water to remove the remaining residual solution on the surface of the base film. The washed polypropylene (PP) base film was purged with the air knife for 10 seconds, and then heat-treated in an oven at a temperature of 80° C. for a treatment time of 3 minutes. After that, a polymer film with enhanced heat resistance and tensile strength was obtained, which is an enhanced polypropylene (PP) film and labeled as S1.

2. The polymer film with enhanced heat resistance and tensile strength obtained by the aforementioned method was used to prepare a composite negative electrode current collector and a composite positive electrode current collector respectively.

### 2.1. Preparation of the Composite Negative Electrode Current Collector

A metal conductive layer was firstly prepared according to the follows. The enhanced polypropylene (PP) film S1 obtained in the above was placed in a vacuum evaporation chamber. A high-purity copper wire with a purity of greater than 99.99% in a metal evaporation chamber was melted at high temperature of 1400° C. to 2000° C. for evaporating. The evaporated metal atoms passed through a cooling system in the vacuum evaporation chamber and deposited on both surfaces of the enhanced PP film S1, forming copper metal conductive layers each with a thickness of 1 μm on the both surfaces respectively.

A protective layer was then prepared. 1 g of carbon nanotubes were uniformly dispersed into a solution containing 999 g of N-methyl pyrrolidone (NMP) through the ultrasonic dispersion process, thereby forming a coating solution with a solid content of 0.1 wt %. The coating solution was uniformly coated onto the surfaces of the metal conductive layer through the die head coating process, with a coating thickness controlled to be 80 μm. The coated metal conductive layer was dried at 100° C. After that, a composite negative electrode current collector was obtained, which is labeled as F1.

### 2.2. Preparation of the Composite Positive Electrode Current Collector

A metal conductive layer was firstly prepared according to the follows. The enhanced polypropylene (PP) film S1 obtained in the above was placed in a vacuum evaporation chamber. A high-purity aluminum wire with a purity of greater than 99.99% in a metal evaporation chamber was melted at a high temperature of 1300° C. to 2000° C. for evaporating. The evaporated metal atoms passed through a cooling system in the vacuum evaporation chamber and deposited on both surfaces of the enhanced PP film S1, forming aluminum metal conductive layers each with a thickness of 1 μm on the both surfaces respectively.

A protective layer was then prepared. 1 g of graphene were uniformly dispersed into a solution containing 999 g of N-methyl pyrrolidone (NMP) through the ultrasonic dispersion process, thereby forming a coating solution with a solid content of 0.1 wt %. The coating solution was uniformly coated onto the surfaces of the metal conductive layer through the die head coating process, with a coating thickness controlled to be 90 μm. The coated metal conductive layer was dried at 100° C. After that, a composite positive electrode current collector was obtained, which is labeled as Z1.

### Example 2

Example 2 was basically the same as Example 1, with the following differences.

The concentration of the solution containing 3,3′-((perfluoropropane-2,2-diyl) bis(4,1-phenylene)) bis(3-(trifluoromethyl)-3H-diazirine) as the crosslinking agent was 50 g/L.

In the crosslinking treatment for modification, the soaking was performed for 40 minutes and the temperature of the solution containing the crosslinking agent was 95° C. during the soaking process; the polypropylene (PP) base film was purged with the air knife for 20 seconds and the washing time was 2 minutes during the washing process; the washed polypropylene (PP) base film was purged with the air knife for 30 seconds, the temperature for heat treatment was 90° C. and the heat treatment time was 1 minute during the heat treatment process.

After that, a polymer film with enhanced heat resistance and tensile strength was obtained, which is an enhanced polypropylene (PP) film and labeled as S2. The obtained composite negative electrode current collector was labeled as F2, and the obtained composite positive electrode current collector was labeled as Z2.

### Example 3

Example 3 was basically the same as Example 1, with the following differences.

The concentration of the solution containing 3,3′-((perfluoropropane-2,2-diyl) bis(4,1-phenylene)) bis(3-(trifluoromethyl)-3H-diazirine) as the crosslinking agent was 80 g/L.

In the crosslinking treatment for modification, the soaking was performed for 60 minutes and the temperature of the solution containing the crosslinking agent was 40° C. during the soaking process; the polypropylene (PP) base film was purged with the air knife for 5 seconds and the washing time was 3 minutes during the washing process; the washed polypropylene (PP) base film was purged with the air knife for 25 seconds, the temperature for heat treatment was 50° C. and the heat treatment time was 3 minutes during the heat treatment process.

After that, a polymer film with enhanced heat resistance and tensile strength was obtained, which is an enhanced polypropylene (PP) film and labeled as S3. The obtained composite negative electrode current collector was labeled as F3, and the obtained composite positive electrode current collector was labeled as Z3.

### Example 4

Example 4 was basically the same as Example 1, with the following differences.

The concentration of the solution containing 3,3′-((perfluoropropane-2,2-diyl) bis(4,1-phenylene)) bis(3-(trifluoromethyl)-3H-diazirine) as the crosslinking agent was 110 g/L.

In the crosslinking treatment for modification, the soaking was performed for 5 minutes and the temperature of the solution containing the crosslinking agent was 100° C. during the soaking process; the polypropylene (PP) base film was purged with the air knife for 30 seconds and the washing time was 0.5 minutes during the washing process; the washed polypropylene (PP) base film was purged with the air knife for 5 seconds, the temperature for heat treatment was 80° C. and the heat treatment time was 2 minutes during the heat treatment process.

After that, a polymer film with enhanced heat resistance and tensile strength was obtained, which is an enhanced polypropylene (PP) film and labeled as S4. The obtained composite negative electrode current collector was labeled as F4, and the obtained composite positive electrode current collector was labeled as Z4.

### Example 5

Example 5 was basically the same as Example 1, with the following difference.

The concentration of the solution containing 3,3′-((perfluoropropane-2,2-diyl) bis(4,1-phenylene)) bis(3-(trifluoromethyl)-3H-diazirine) as the crosslinking agent was 140 g/L.

After that, a polymer film with enhanced heat resistance and tensile strength was obtained, which is an enhanced polypropylene (PP) film and labeled as S5. The obtained composite negative electrode current collector was labeled as F5, and the obtained composite positive electrode current collector was labeled as Z5.

### Example 6

Example 6 was basically the same as Example 1, with the following difference.

The concentration of the solution containing 3,3′-((perfluoropropane-2,2-diyl) bis(4,1-phenylene)) bis(3-(trifluoromethyl)-3H-diazirine) as the crosslinking agent was 170 g/L.

After that, a polymer film with enhanced heat resistance and tensile strength was obtained, which is an enhanced polypropylene (PP) film and labeled as S6. The obtained composite negative electrode current collector was labeled as F6, and the obtained composite positive electrode current collector was labeled as Z6.

### Example 7

Example 7 was basically the same as Example 1, with the following difference.

The concentration of the solution containing 3,3′-((perfluoropropane-2,2-diyl) bis(4,1-phenylene)) bis(3-(trifluoromethyl)-3H-diazirine) as the crosslinking agent was 200 g/L.

After that, a polymer film with enhanced heat resistance and tensile strength was obtained, which is an enhanced polypropylene (PP) film and labeled as S7. The obtained composite negative electrode current collector was labeled as F7, and the obtained composite positive electrode current collector was labeled as Z7.

### Example 8

Example 8 was basically the same as Example 1, with the following differences.

The crosslinking agent was 1,3-bis(3-(trifluoromethyl)-3H-diazirin-3-yl)-2-(trifluoromethyl) benzene. The solvent was a mixed solvent of acetone and N, N-dimethylformamide at a volume ratio of 1:1. The concentration of the solution containing the crosslinking agent was 100 g/L.

After that, a polymer film with enhanced heat resistance and tensile strength was obtained, which is an enhanced polypropylene (PP) film and labeled as S8. The obtained composite negative electrode current collector was labeled as F8, and the obtained composite positive electrode current collector was labeled as Z8.

### Example 9

Example 9 was basically the same as Example 1, with the following differences.

A commercially available polyethylene terephthalate (PET) film with a thickness of 5 μm was selected as the polymer film (i.e., base film).

The crosslinking agent was a mixture of 3,5-bis(3-(trifluoromethyl)-3H-diazirin-3-yl) pyridine and 1,3-bis(3-(trifluoromethyl)-3H-diazirin-3-yl)-2-(trifluoromethyl) benzene at a mass ratio of 2:1. The solvent was a mixed solvent of acetone, N, N-dimethylformamide and pyridine at a volume ratio of 1:1:1. The concentration of the solution containing the crosslinking agent was 120 g/L.

After that, a polymer film with enhanced heat resistance and tensile strength was obtained, which is an enhanced polyethylene terephthalate (PET) film and labeled as S9. The obtained composite negative electrode current collector was labeled as F9, and the obtained composite positive electrode current collector was labeled as Z9.

### Comparative Example 1

A commercially available polypropylene (PP) film with a thickness of 4.5 μm without treatment was used as the substrate. The composite positive electrode current collector and the composite negative electrode current collector were prepared according to the method in Example 1 for comparison. Among them, the commercially available PP film with the thickness of 4.5 μm without treatment was labeled as B1, the prepared composite negative electrode current collector was labeled as BF1, and the composite positive electrode current collector was labeled as BZ1.

### Comparative Example 2

A commercially available polyethylene terephthalate (PET) film with a thickness of 5 μm without treatment was used as the substrate. The composite positive electrode current collector and the composite negative electrode current collector were prepared according to the method in Example 1 for comparison. Among them, the commercially available PET film with the thickness of 5 μm without treatment was labeled as B2, the prepared composite negative electrode current collector was labeled as BF2, and the composite positive electrode current collector was labeled as BZ2.

The purpose of preparing the enhanced polymer film as mentioned above is to improve the heat resistance and tensile strength of the polymer film. The tensile strength and heat shrinkage rate of the enhanced polymer films and the common polymer films were tested in accordance with the National Standards GB/T 1040.3-2006 and GB/T 10003-2008 for evaluation. The test results are shown in Table 1. MD represents the machine direction of the film and TD represents the transverse direction of the film. The data of heat shrinkage rate were obtained after heat treatment at 120° C. for 15 minutes.

TABLE 1
Test results of performances of enhanced
polymer films and common polymer films

| | | |
|---|---|---|
| Tensile | Elongation | Heat shrinkage |
| strength (MPa) | at break (%) | rate (%) |

| No. | MD | TD | MD | TD | MD | TD |
|---|---|---|---|---|---|---|
| S1 | 200 | 295 | 135 | 63 | 3.5 | 1.0 |
| S2 | 229 | 309 | 121 | 60 | 3.0 | 0.8 |
| S3 | 257 | 325 | 105 | 58 | 2.4 | 0.55 |
| S4 | 281 | 337 | 93 | 55 | 1.5 | 0.39 |
| S5 | 301 | 345 | 82 | 50 | 1.01 | 0.18 |
| S6 | 320 | 351 | 65 | 41 | 0.81 | 0.12 |
| S7 | 336 | 363 | 49 | 35 | 0.61 | 0.1 |
| S8 | 265 | 330 | 101 | 57 | 2.1 | 0.43 |
| S9 | 241 | 354 | 113 | 43 | 2.1 | 0.5 |
| B1 | 178 | 280 | 150 | 65 | 4.0 | 1.2 |
| B2 | 213 | 324 | 132 | 54 | 3.3 | 0.8 |

The performances such as film breakage rate, tensile strength, and heat shrinkage rate of the composite negative electrode current collectors and the composite positive electrode current collectors prepared with the enhanced polymer films and the common polymer films were tested respectively. The test results are shown in Table 2 and Table 3. The data of heat shrinkage rate were obtained after heat treatment at 120° C. for 15 minutes.

TABLE 2
Test results of performances of composite
negative electrode current collectors

| | | |
|---|---|---|
| | Elongation at | Heat shrinkage |
| Film breakage | break (%) | rate (%) |

| No. | rate (%) | MD | TD | MD | TD |
|---|---|---|---|---|---|
| F1 | 9 | 102 | 170 | 0.3 | 0.2 |
| F2 | 3 | 127 | 182 | 0.2 | 0.13 |
| F3 | 0 | 151 | 198 | 0.1 | 0.08 |
| F4 | 0 | 179 | 208 | 0.05 | 0.03 |
| F5 | 0 | 197 | 218 | 0.04 | 0.02 |
| F6 | 0 | 215 | 233 | 0.02 | 0.01 |
| F7 | 2 | 232 | 241 | 0.01 | 0.01 |
| F8 | 0 | 162 | 202 | 0.07 | 0.05 |
| F9 | 0 | 159 | 224 | 0.04 | 0.01 |
| BF1 | 15 | 88 | 161 | 0.6 | 0.3 |
| BF2 | 11 | 76 | 152 | 0.5 | 0.2 |

TABLE 3
Test results of performances of composite
positive electrode current collectors

| | | |
|---|---|---|
| | Elongation at | Heat shrinkage |
| Film breakage | break (%) | rate (%) |

| No. | rate (%) | MD | TD | MD | TD |
|---|---|---|---|---|---|
| Z1 | 7 | 153 | 243 | 0.5 | 0.3 |
| Z2 | 2 | 178 | 255 | 0.35 | 0.3 |
| Z3 | 0 | 206 | 266 | 0.2 | 0.19 |
| Z4 | 0 | 232 | 271 | 0.15 | 0.11 |
| Z5 | 0 | 251 | 278 | 0.09 | 0.08 |
| Z6 | 0 | 267 | 279 | 0.06 | 0.05 |
| Z7 | 1 | 273 | 288 | 0.05 | 0.04 |
| Z8 | 0 | 224 | 268 | 0.18 | 0.15 |
| Z9 | 0 | 256 | 276 | 0.04 | 0.02 |
| BZ1 | 12 | 129 | 225 | 0.8 | 0.6 |
| BZ2 | 9 | 118 | 204 | 0.6 | 0.4 |

From the above test results, it can be seen that the polymer film treated with the crosslinking agent has significantly improved tensile strength, greatly reduced heat shrinkage rate, and increased heat resistance, indicating that the present method is capable of improving the tensile strength and heat resistance of the polymer film.

With the increase of the concentration of the crosslinking agent, the prepared enhanced PP films show a trend of increasing the tensile strength and decreasing the heat shrinkage rate and improving the heat resistance. Thus, during the preparation of the composite current collector with this enhanced PP film as the substrate, the film breakage rate was significantly reduced, and the prepared composite current collector has significantly improved tensile strength and heat resistance. However, with the further increase of the concentration of the crosslinking agent, the elongation at break shows a decreasing trend. When the concentration of the crosslinking agent reaches 200 g/L, the elongation at break of the prepared enhanced PP film decreases to be less than 50%, and the PP film becomes relatively brittle. Thus, during the preparation of the composite current collector with this PP film as the substrate, the external friction or scratch may break the film, causing the film breakage rate to increase from 0% to 2%. Therefore, the concentration of the crosslinking agent may not exceed 200 g/L, with an optimal concentration ranging from 80 g/L to 170 g/L.

The above descriptions are merely some embodiments of the present disclosure and are not intended to limit the present disclosure. Any modifications, equivalent substitutions, improvements, etc., made within the design concept of the present application should be included in the protection scope of the present disclosure.

1. A method for preparing a polymer film, comprising:
(i) soaking a polymer film in a solution containing a crosslinking agent for a crosslinking reaction;
(ii) washing the polymer film obtained after step (i) to remove residue solution; and
(iii) heat-treating the washed polymer film in an oven;
wherein the crosslinking agent is capable of forming carbene intermediates.

2. The method according to claim 1, wherein during the soaking in step (i), the soaking is performed for a time period ranging from 5 to 60 minutes, and the solution containing the crosslinking agent has a temperature ranging from 40° C. to 110° C.

3. The method according to claim 1, wherein during the washing in step (ii), the polymer film is washed in deionized water for a time period ranging from 0.5 to 3 minutes to remove residual solution on the surface of the polymer film.

4. The method according to claim 1, wherein during the heat treatment of step (iii), the washed polymer film is heat-treated in an oven at a temperature ranging from 50° C. to 90° C. for a time period ranging from 1 to 5 minutes.

5. The method according to claim 1, wherein a base material of the polymer film is one or more selected from polypropylene, polyethylene, polyethylene terephthalate, polybutylene terephthalate, polyethylene naphthalate, polyimide, polypropyl ethylene, polyvinyl chloride, polyvinylidene fluoride, polytetrafluoroethylene, polyphenylene sulfide, polyphenylene oxide, polystyrene, derivatives thereof, and copolymers thereof.

6. The method according to claim 1, wherein the crosslinking agent comprises a compound of Formula I: 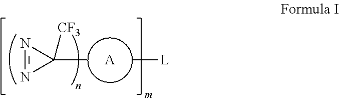
wherein:
A is an aryl group selected from substituted or unsubstituted phenyl, substituted or unsubstituted pyridine, and substituted or unsubstituted biphenyl, in which the substituent is each independently selected from halogen, hydroxyl, C1-C8 alkyl, C1-C8 haloalkyl, C1-C8 alkoxyl, C3-C8 cycloalkyl, and C3-C8 halocycloalkyl;
L is selected from a bond, and substituted or unsubstituted C1-C8 alkyl, in which the substituent is each independently selected from halogen, hydroxyl, C1-C8 alkyl, C1-C8 haloalkyl, C1-C8 alkoxyl, C3-C8 cycloalkyl, and C3-C8 halocycloalkyl;
m is an integer selected from 1, 2, 3, and 4;
n is an integer selected from 1, 2, and 3.

7. The method according to claim 6, wherein the crosslinking agent comprises one or more compounds selected from:

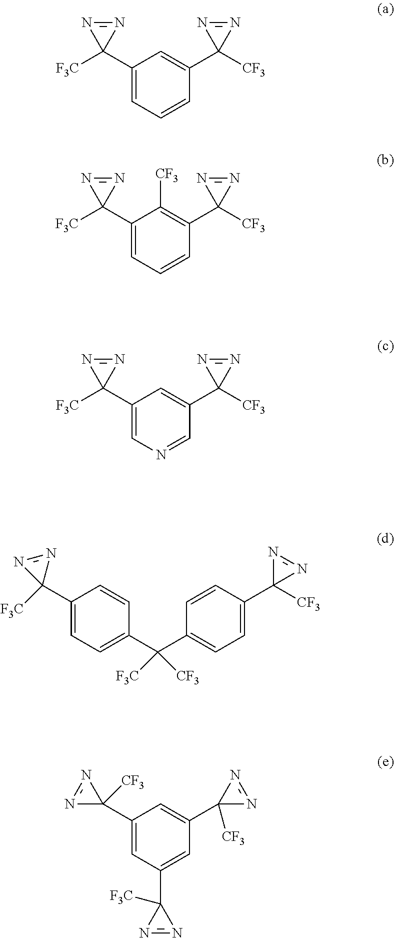 [SMILES: FC(F)(F)C1(c2cccc(C3(C(F)(F)F)N=N3)c2)N=N1 ; FC(F)(F)c1c(C2(C(F)(F)F)N=N2)cccc1C1(C(F)(F)F)N=N1 ; FC(F)(F)C1(c2cncc(C3(C(F)(F)F)N=N3)c2)N=N1 ; FC(F)(F)C1(c2ccc(C(c3ccc(C4(C(F)(F)F)N=N4)cc3)(C(F)(F)F)C(F)(F)F)cc2)N=N1 ; FC(F)(F)C1(c2cc(C3(C(F)(F)F)N=N3)cc(C3(C(F)(F)F)N=N3)c2)N=N1]

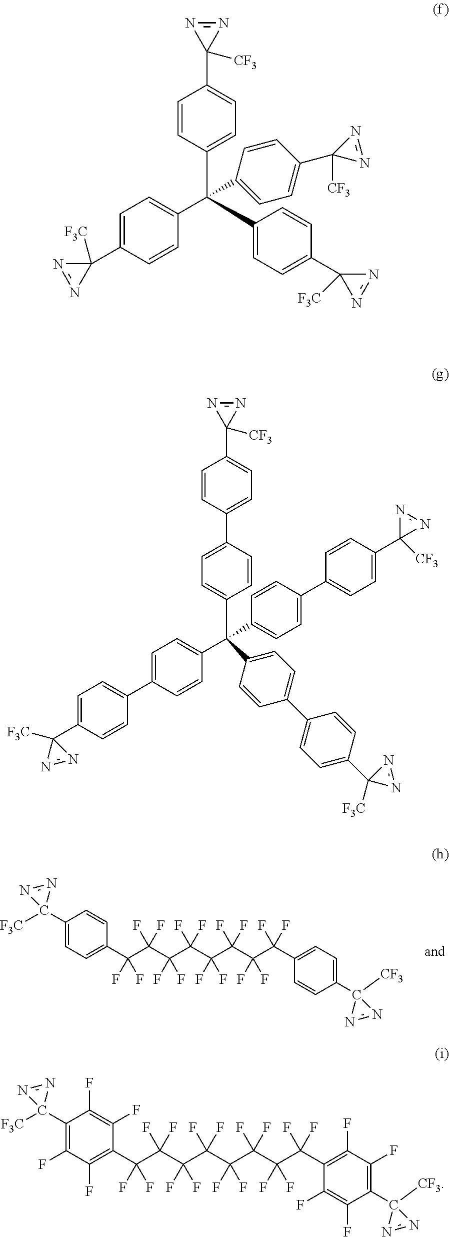

8. The method according to claim 1, wherein the solution containing the crosslinking agent comprises at least one solvent selected from ethyl ether, acetone, N, N-dimethylformamide, N, N-dimethylacetamide, pyridine, 2-dimethylpyridine, pyridone, and benzene.

9. The method according to claim 1, wherein a concentration of the crosslinking agent in the solution containing the cross-linking agent ranges from 5 to 200 g/L.

10. A polymer film prepared by the method according to claim 1.

11. A polymer film, comprising:
a repetitive moiety selected from: 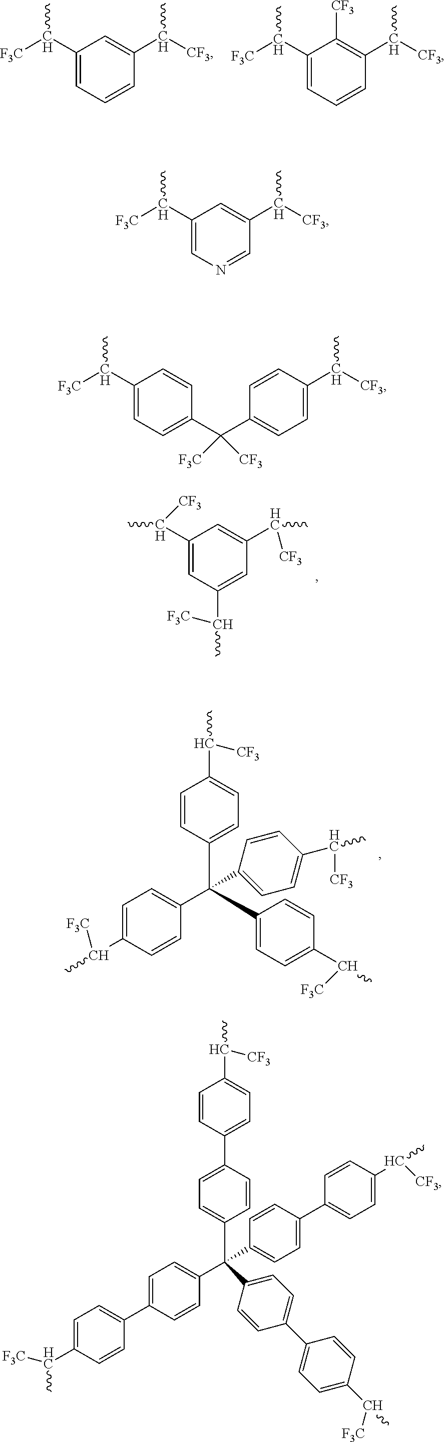 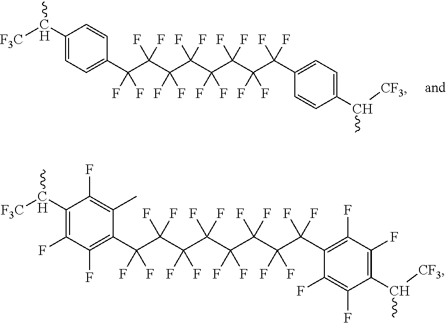
and
a polymeric network formed by one or more base materials selected from polypropylene (PP), polyethylene (PE), polyethylene terephthalate (PET), polybutylene terephthalate (PBT), polyethylene naphthalate (PEN), polyimide (PI), polypropyl ethylene, polyvinyl chloride (PVC), polyvinylidene fluoride (PVDF), polytetrafluoroethylene (PTFE), polyphenylene sulfide (PPS), polyphenylene oxide (PPO), polystyrene (PS), derivatives thereof, and copolymers thereof.

12. The polymer film according to claim 11, wherein the repetitive moiety constitutes 0.1 wt % to 2.0 wt % based on the total weight of the polymer film.

13. A composite current collector, comprising:
a polymer film comprising a repetitive moiety selected from: 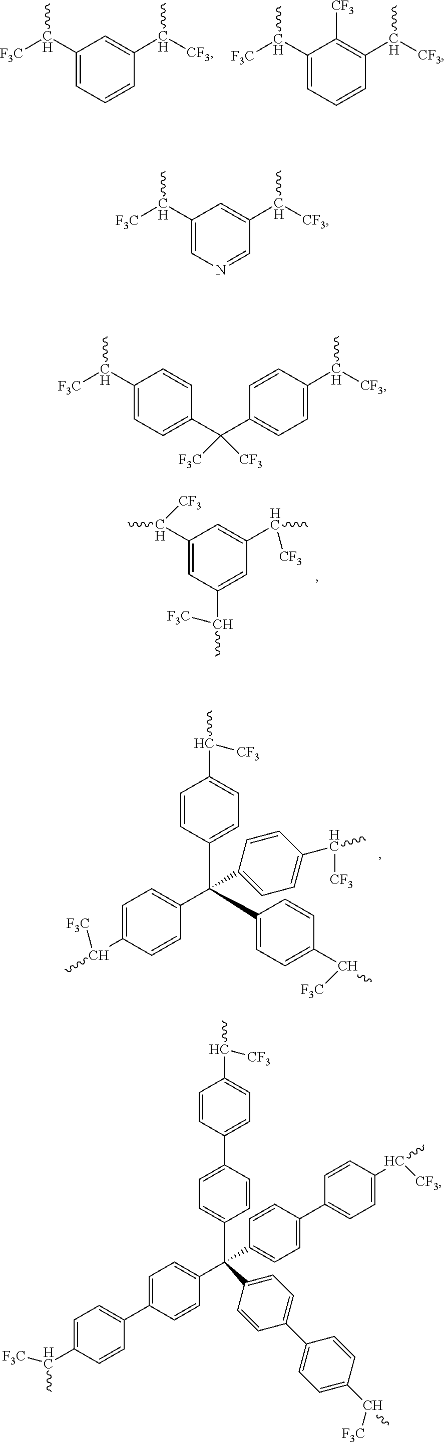 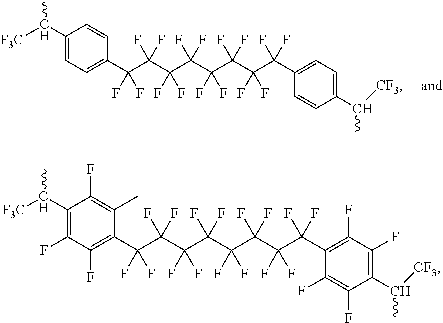
a polymeric network formed by one or more base materials selected from polypropylene, polyethylene, polyethylene terephthalate, polybutylene terephthalate, polyethylene naphthalate, polyimide, polypropyl ethylene, polyvinyl chloride, polyvinylidene fluoride, polytetrafluoroethylene, polyphenylene sulfide, polyphenylene oxide, polystyrene, derivatives thereof, and copolymers thereof; and
metal layers disposed on two opposing surfaces of the polymer film.

14. The composite current collector according to claim 13, further comprising at least one protective layer on the surface of the metal layers, wherein the protective layer comprises one or more selected from nickel, chromium, nickel-based alloys, copper-based alloys, copper oxide, aluminum oxide, nickel oxide, chromium oxide, copper chromate, cobalt oxide, graphite, carbon black, acetylene black, Ketjen black, carbon nano quantum dots, carbon nanotubes, carbon nano fiber, and graphene.

15. A battery comprising a composite current collector according to claim 13.
